(19) United States
(12) Patent Application Publication
(10) Pub. No.: US 2026/0170124 A1
(43) Pub. Date: Jun. 18, 2026

(54) DETECTING AND MITIGATING SECURITY RISKS IN GENERATIVE MODEL APPLICATIONS

(71) Applicant: Microsoft Technology Licensing, LLC, Redmond, WA (US)

(72) Inventors: Shimon EZRA, Petach Tikva (IL); Slava REZNITSKY, Rishon LeZion (IL); Andrey KARPOVSKY, Kiryat Motzkin (IL); Shiran HOREV, Tel Aviv (IL)

(21) Appl. No.: 18/979,570

(22) Filed: Dec. 12, 2024

(51) Int. Cl. G06F 21/55

(52) U.S. Cl. CPC G06F 21/55

(57) ABSTRACT

Various security mechanisms are considered for detecting and mitigating potential security risks posed by generative artificial intelligence. In one example, a generative model prompt is separated into a meta prompt part and an input prompt part, which in turn are separately encoded. Based on the resulting meta prompt embedding vector and input prompt embedding vector, the prompt is identified as anomalous, which in turn triggers an appropriate security action. In one example implementation, the meta prompt embedding vector is used to classify the prompt (e.g. by application type or application flow type), and the input prompt embedding vector is used for context-aware anomaly detection, using a class assigned to the prompt based on its meta prompt embedding vector. In another example implementation, the prompt is identified as anomalous based on distance between the meta prompt and input prompt embedding vector.

### TECHNICAL FIELD

The present disclosure pertains to cybersecurity, and in particular to mechanisms for mitigating against emerging security risks posed by increasing adoption of generative models across a diverse range of applications.

### BACKGROUND

In the field of artificial intelligence (AI), large language models (LLMs) and other generative models (GMs), have seen significant advancements in recent years. Generative models are a class of machine learning model(s) and are capable of generating new data instances. More formally, such models are trained to estimate a joint probability distribution over inputs and outputs from which new outputs can be sampled. The term generative AI (GAI) refers to functionality implemented using one or more such generative models.

A characteristic of many modern GMs is their general applicability, meaning they can, to varying degrees, be usefully applied at inference to tasks on which they have not been specifically trained. Such GMs, once trained, are therefore able to support a wide range of applications. One deployment scenario for GMs is through an application programming interface (API) that developers can use to build custom applications. In this scenario, a GM is hosted on a server, and an application interact with the GM via API calls. This setup allows developers to integrate GM capabilities into their applications without needing to manage the underlying infrastructure or model training processes.

Modern language models, such as GPT-3 and GPT-4, are known for their ability to generate human-like text in response to open natural language prompts. Models such as DALL-E can generate complex images in response to text. However, as the field develops, applications are incorporating GAI functionality in increasingly diverse ways. Whilst this opens up many new possibilities for application developments, without appropriate safeguards, it also has the potential to create new security risks. For example, on the input side, an application might expose private or sensitive data to a generative model, using techniques such as retrieval augmented generation (RAG) or in-context learning. On the output side, an application might include automation logic to perform important system functions (such as deleting or modifying data, interfacing with external platforms, sending messages in bulk etc.) based on a GM’s outputs. An attacker may be able to exploit such facets to gain access to secure data, or cause significant damage or disruption to a system whose functionality is exposed in this way.

### SUMMARY

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

Various security mechanisms are considered for detecting and mitigating potential security risks posed by generative artificial intelligence. In one example, a generative model prompt (e.g., a prompt that has been submitted to a generative model, or a prompt yet to be submitted) is separated into a meta prompt part and an input prompt part, which in turn are separately encoded. Based on the resulting meta prompt embedding vector and input prompt embedding vector, the prompt is identified as anomalous, which in turn triggers an appropriate security action. In one example implementation, the meta prompt embedding vector is used to classify the prompt (e.g. by application type or application flow type), and the input prompt embedding vector is used for context-aware anomaly detection, using a class assigned to the prompt based on its meta prompt embedding vector. In another example implementation, the prompt is identified as anomalous based on distance between the meta prompt and input prompt embedding vector.

### BRIEF DESCRIPTION OF FIGURES

Example embodiments will now be described with reference to the following figures, in which:

FIG. 1 is a block diagram of an example system that includes an interface to a generative model and a security system for monitoring usage of the interface;

FIG. 2 is a block diagram of an example prompt for a generative model;

FIG. 3 is a block diagram of an example security system;

FIG. 4A is a flowchart of an example method implemented by a security system;

FIG. 4B is a flowchart of another example method implemented by a security system;

FIG. 4C is a flowchart of an example prompt pre-processing method for a security system; and

FIG. 5 schematically shows an example of a computer system.

In the drawings, corresponding reference characters indicate corresponding components. The skilled person will appreciate that elements in the figures are illustrated for simplicity and clarity. Also, common but well-understood elements that are useful in a commercially feasible embodiment are often not depicted in order to facilitate a less obstructed view of these various example embodiments.

### DETAILED DESCRIPTION

In some deployment scenarios, organizations develop and implement applications on cloud infrastructure. In some deployments, a cloud provider provides security services, and organizations grant limited access to their data for this purpose. In one deployment scenario considered herein, an organization grants the cloud provider access to their generative model prompts as passed via an API or other gateway to a generative model. The cloud provider therefore has access to an organization’s prompts, but does not have “white box” access to their applications. This poses specific security challenges, as different security considerations apply to different applications, but the cloud provider lacks relevant details such as the type of application, whether it is internal or external to the organization, what data or interfaces it is exposing to the generative model. Note, this is merely one example of a deployment scenario in which such challenges arise. Similar considerations apply to any scenario in which a security system has access to such prompts but does not have (or has only limited access to) the applications themselves.

Certain embodiments leverage the insight that different parts of a generative model prompt often serve different purposes. For example, it is common for part of a prompt to define a core intent that remains static for a specific application or application flow, whilst another part of a prompt varies with each generative model interaction. By separating a “meta prompt” part from an “input prompt” part in a security system, and separately encoding those parts into separate embedding vectors for use in a security analysis, it is possible to extract better security insights in scenario such as those described above, yielding a consequence improvement in the security of an application or operational system (e.g., a system hosting one or more applications) that is monitored and protected by the security system. Certain embodiments determine an application type using the meta prompt part, meaning the prompt can be linked to a specific application type. This, in turn, enables functions such as application-specific anomaly detection (e.g., identifying an input prompt embedding vector that is anomalous with respect to its associated application type), or application-specific remediation (e.g., causing or recommending a modification to an application or related infrastructure based on its identified type).

In the present context, a “meta prompt” part refers to a first part of a GM prompt that is determined or assumed to be associated with an application or a flow within an application (application flow) and remain stable across prompts associated with the same application or application flow. An application flow refers to a subset of interactions that use a common, syntactically stable meta prompt. Some applications have only a single flow in this sense, whilst others have multiple flows that are treated separately. An “input prompt” part refers to a second part of a GM prompt that is determined or assumed to vary between GM prompts associated with the application flow. Meta prompt parts are reused whereas input prompt parts are not routinely reused. For example, an application might generate a GM prompt by populating a template prompt (containing a meta prompt part) with input data. In some scenarios, GM prompts are submitted to an API or other gateway in structured prompt objects, with separate meta prompt and input prompt fields. In other scenarios, GM prompts are unstructured. Some embodiments identify meta prompt parts based on a syntactic analysis across multiple GM prompts (identifying a meta prompt part that is syntactically similar to parts of other prompts). This is useful even when structured prompt objects are used, as there is no guarantee that application developers will use the prompt object structure as intended.

Note the term “prompt” is used broadly to refer to any form of input for a generative model. This includes, without limitation, open natural language prompts, structured prompts, images, audio data etc.

Organizations today are developing applications incorporating GAI functionality at pace. It is not uncommon for an organization to have hundreds or thousands of such applications for different scenarios. Many such applications incorporate LLMs. An LLM is a trained language model. Certain LLMs have a transformer deep learning architecture. An LLM is trained on a very large corpus (e.g., in the order of billions of tokens), and can generate outputs such as text, image, audio, executable code and/or any other data in response to a prompt received as input. LLMs typically have of the order of a billion parameters or more, with certain LLMs having hundreds of billions of parameters. Sometimes, a distinction is drawn between “large” language models and “small” language models, although current state-of-the-art small language models typically still have of the order of a billion parameters or more. Choosing an appropriate size and training for a GM sometimes involves a trade-off between the model’s performance on domain-specific tasks and its ability to generalize across domains. The following description considers language model(s) (LMs), which for the avoidance of doubt includes large language models and small language models. The description also applies to other GMs such as generative vision models, audio models, multi-modal models etc.

An example of a suitable LM is the Open AI General Pretrained Transformer (GPT) model, for example GPT-3, GPT-3.5 turbo, GPT-4 or GPT Omni (e.g., GPT-4o). However, a variety of LMs may be employed in the alternative. In addition to GPT models, other architectures include Falcon, Llama etc. Furthermore, multi-modal models like CLIP (Contrastive Language–Image Pretraining) and DALL-E, which can process and generate both text and images. Certain GMs are unimodal in their inputs but multimodal in their outputs, or vice versa. Certain GMs are unimodal in their inputs and outputs, but with different input and output modalities (e.g. unimodal text input with unimodal image output). Unless otherwise indicated, the term multi-modal encompasses all of the aforementioned possibilities. Certain GMs are unimodal but operate on a modality other than text, such as image or audio. For example, direct audio-to-audio generative architectures have recently been developed.

The approach described herein identifies potentially harmful scenarios (e.g., by application, flows and/or category) by analyzing a meta prompt, model in use and AI tools in use and connecting it to other sources. As discussed, LM applications often include a meta prompt part in a prompt to be submitted to a GM model. In some cases, the meta prompt has a standard structure with fixed text. The meta prompt part is assumed to remain substantially static across the life cycle of an application, but as discussed is sometimes different for each flow within an application.

Certain example embodiments detect potential attacks or attempted attacks on applications that access GAI functionality via an interface, such as an API or other gateway, between the application and one or more generative models. A security system communicatively coupled to the interface identifies meta prompt and input prompts parts in prompts submitted to the interface, and applies an enhanced form of anomaly detection. The anomaly detection is context and categorization aware, and improved anomaly detection is achieved by leveraging application history and identified application intent and category (examples of categories include finance, sales, HR, email summary app, chat bot app etc., which all have different security considerations). This allows potential vulnerabilities and loopholes of an organization to be determined thus affording the organization runtime protection.

Various embodiments are described in detail below. A brief overview of certain embodiments is first provided.

A meta prompt part is separated from an input prompt part of a prompt, based on syntactic similarity with other prompts that have been collected. The meta prompt part is expected to be syntactically stable across an application or application flow such that it rarely changes and even after a change there is a relatively level of syntactic similarity to the previous version. In embodiments, this can be identified by semantic similarity matching.

Whilst “semantic” similarity relates to similarity in meaning (ascertained by comparing embedding vectors in some implementations), “syntactic” similarity relates so similarity in syntax (e.g. based on a direct comparison of characters, substrings, tokens etc. between strings in some implementations).

The meta prompt part and input prompt part are encoded and separated, resulting in a meta prompt embedding vector and a separate input prompt embedding vector for each prompt.

In some implementations, a single embedding vector encoding the meta prompt and another single embedding vector encoding the input prompt are generated. Encoding data into embedding vectors is a way to move information from different formats and sizes into a single vector space, thus allowing common operations. For example, some implementations encode a meta prompt part of a prompt in the same embedding space and an input part of a prompt. In some cases, language model (e.g., LLM) are used for this purpose. Certain language models provide an embedding per token. However, embedding vectors coming from different sources (such as meta- and input prompt parts) can be combined using a variety of techniques (e.g. pairwise element average). For example, in some implementations, a first subset of token embeddings belonging to an meta prompt part are combined into a single prompt embedding vector and a second subset of token embeddings belonging to an input prompt part are combined into an input prompt embedding vector.

Certain embodiments use two levels of clustering, for classification and context-aware anomaly detection respectively. Other classification methods and context-aware anomaly detection methods are also envisaged.

First, classification based on meta prompt parts is performed. Prompts are clustered based on their meta prompt embedding vectors, to classify them according to application or application flow (each meta prompt cluster corresponds to the same application or flow as these would have semantically similar meta prompt parts). This gives additional insights beyond the syntactic matching of 1, because meta prompt semantics are now also considered (e.g., prompts with syntactically different but semantically similar meta prompt parts may be assigned to the same meta prompt cluster).

Second, anomaly detection based on input prompt parts is performed. For a given class (e.g., a given meta prompt cluster identified in the first clustering step described above), additional clustering of the subset of prompts within it based on their input prompt embedding vectors is performed. Anomalous prompts are flagged as outliers that do not belong to any of the resulting input prompt clusters. This is one way of implementing context-aware anomaly detection. Context-awareness, in this case, is achieved by clustering input prompt embedding vectors within their respective meta prompt classes, leveraging the insight that an input prompt embedding vector that is anomalous within a first meta prompt class (e.g., application type) would not necessarily be anomalous within a second meta prompt class (e.g., application type).

In embodiments, the classification based on the meta prompt is alternatively or additionally used for other risk tracking including (among other things) anomalies flow, usage by users, sensitivity of data and compliance requirements based on categories.

A semantic comparison between the input prompt embedding vector and the meta prompt embedding vector is performed by computing distance between them in embedding space. As outlined above, some implementations implement anomaly detection based on input prompt clustering. However, there are other ways in which input prompt and meta prompt embedding vectors can be used. For example, some embodiments identify prompts as anomalous and/or implement anomaly detection based on distance in embedding space between the input prompt embedding vector and the meta prompt embedding vector. A large distance implies an input prompt is semantically very different to its meta prompt.

However, some semantic dissimilarity between the input prompt part and meta prompt part is expected, but within range that is specific to application type. For example, some applications have more stable patterns in their respective prompts than others. Hence, some embodiments combine classification based on the meta prompt embedding vector with a semantic comparison between the meta prompt embedding vector and the input prompt embedding vector, e.g. comparing the distance between those embedding vectors with a class-specific threshold associated with the class to which the prompt is assigned.

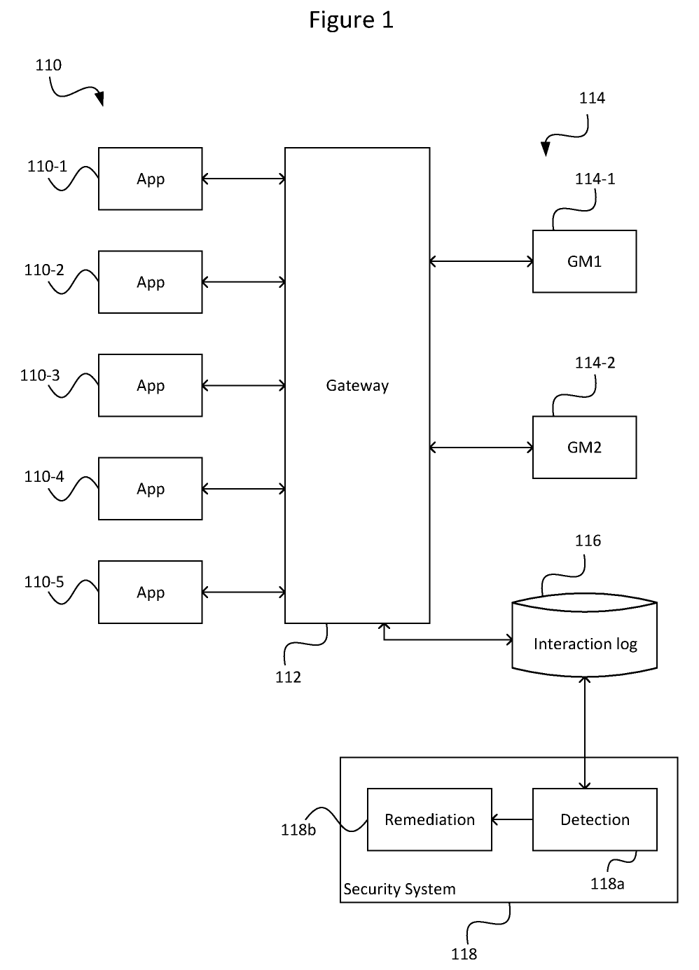

FIG. 1 shows a block diagram of an example system, which in turn is shown to comprise a plurality of applications 110, a gateway 112, a plurality of generative models 114, and interaction log 116 and a security system 118. In this example, first to fifth applications 110-1,,…,110-5 are depicted, and first and second generative models 114-1, 114-2 are depicted. This is merely illustrative, and the mechanisms described below can be applied with any number of applications and any number of generative models, including a single generative model.

The applications 110 are hosted in one or more operational systems (not depicted), and interact with the gateway 112 (which is an API in some implementation) to access and utilize the generative machine learning models 114, such as LMs. The gateway 112 serves multiple applications 110 in front of the generative models 114, as shown in FIG. 1. In some implementations, an operational system hosting one or more applications is a virtual system implemented on a cloud platform, and the security system 118 provides system security within the cloud platform.

The gateway 112 interfaces with the generative models 114 by passing prompts from the applications 110 to the generative models 114, receiving generative-model responses, and passing the model-generated responses back to the applications 110. In some implementations, the gateway 112 passes prompts and/or responses selectively, e.g. a prompt identified as anomalous is blocked in some cases. The prompts are received by the gateway 112 from any one of the applications, for example application 110-2, and include instructions that, when processed by, for example GM2 114-2, cause the generative model 114-2 to provide a desired response. The generative model 114-2, that received the prompt submits a response to the gateway 112 and the gateway 112 relays the response to the application 110-2. The prompts are generated by users of the application 110-2 which may not be associated with the organization that created the application 110-2. In some deployment scenarios, users of the applications generate the prompts and that organisations have (intentionally or unintentionally) limited control over what users put in the prompts. The techniques described herein mitigate against the security risks posed in this scenario.

In some examples, the generative models 114 are configured to receive text as input and generate text in response. Accordingly, in this context, instructions to be processed by the generative models 114 refer to instructions provided in a natural language that can be received in prompts by the generative models 114 and processed thereby. Such instructions generally comprise a textual explanation of the task and the form of the desired response. In some cases, instructions comprise further contextual information that assists the generative models 114 in performing the task, such as a description of a persona to adopt, a description of relevant rules or conventions required to provide the output.

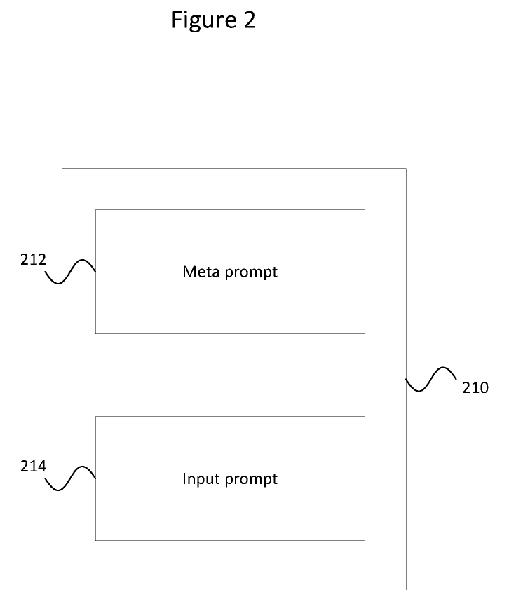

The following examples consider prompts received by the gateway 112 from the applications 110 that comprise two main elements, a meta prompt part and an input prompt part which are described in more detail in relation to FIG. 2 below.

The gateway 112 captures copies of the prompts from the applications 110 and responses from the generative models 114 and stores them in an interaction log 116. In some implementations, the interaction log 116 is implemented as a database. The stored copies of the prompts in the interaction log 116 are then accessible to the security system 118.

The security system 118 is shown to comprise a detection component 118a and a remediation component 118b, which represent different aspects of the security system’s functionality. The detection component 118a analyses signals (such as the stored prompts in the interaction log 116) to detect potential security threats whilst the remediation component 118b responds to such threats.

The detection component 118a analyses the prompts in the interaction log 116 to determine what the applications 110 are using the models 114 for and in which category each of the applications 110-1 to 110-5 belongs. This is described in more detail below.

The parts of the prompts are analyzed and, depending on whether the detection component 118a identifies any suspicious or anomalous content which presents a security threat, the remediation component 118b implements one or more security measures to reduce the security threat. In embodiments, the detection component 118a identifies an anomalous prompt submitted to the gateway 112 by one of the applications and determines that the anomaly presents a security threat. An anomaly can, for example, correspond to a user or agent using or attempting an application to access an abnormally large amount data or an abnormal type of class data from the generative models via the gateway 112. What constitutes “abnormal” is context-specific in some cases, e.g., with a user or agent attempting to access an amount or type of data that is abnormal in respect of a given application type.

Various forms of remediation action, or security action, are considered. For example, in some embodiments, the remediation component 118b generates an alert to an output device of an organization or administrator user that created or manages an application for which anomalous activity has been detected. In other embodiments, the remediation component 118b alternatively or additionally automatically implements or recommends changing or modifying the application that submitted the prompt in response to the detection of the security threat. Alternatively or additionally, in some embodiments, the remediation component 118b restricts, isolates, deactivates or quarantines the application that provided the prompt thus fully or partially suspending its access to the GAI functionality via the gateway 112. In other embodiments, the remediation component 118b blocks the prompt reaching the generative model. Alternatively, the remediation component blocks model-generated responses from the generative model reaching the application that provided the prompt. Note the terms “remediation” and “security action” are used broadly herein and encompasses (among other things) risk reduction actions or corrective remediation actions. A security action can be any action that achieves a security improvement.

In some implementations, the applications 110, gateway 112 and the generative models 114 are part of a cloud computing or other distributed environment. In some implementations, the models 114 are alternatively or additionally accessible via the gateway 112 over a network. For example, in some implementations, the applications are developed by third party organizations which are hosted on the cloud computing platform or a distributed network. As discussed above, in some deployment scenarios, the host of the cloud platform manages the gateway 112 but does not have access to the application to determine its nature or intent. In some deployment scenarios, the cloud platform hosts a generative model accessible via the gateway 112. In some deployment scenarios, the gateway 112 alternatively or additionally provides access to a “third-party” generative model hosted externally to the cloud platform.

The architecture of FIG. 1 strikes a balance between, on the one-hand, enabling the security system 118 to provide risk context-aware detection and remediation functions, whilst on the other hand maintaining privacy and confidentiality of the applications 110. Prompt analysis provides sufficient context-awareness to implement effective security measures, without requiring white box access to the applications 110. Such analysis enables, for example, an origin of each logged interaction via the gateway 112 (e.g., each API call to a generative model) to be identified. The security system 118 uses logged interactions (e.g., API call history) to categorize application intent, and to identify different flow within each application, enabling for example different types of anomaly detection for each flow. This increases the accuracy of the anomaly detection, thus increasing the level of security in the applications 110 and/or the operational system(s) hosting the applications 110.

FIG. 2 is a block diagram of an example prompt 210, which is shown to comprise a meta prompt part 212 and an input prompt part 214.

As mentioned above, the gateway 112 receives a prompt 210 from one of the applications 110. The prompt 210 is structured in some implementation and unstructured in others. With unstructured prompts, additional processing is used to identify the meta prompt part 212 and the input prompt part 214. Even if the prompt is structured, the boundary between the information contained within the meta prompt part 212 and the input prompt part 214 is not guaranteed to be reflected in the prompt structure (e.g., if the prompt structure is not used as intended). For example, in some cases, information in the meta prompt part 212 could be wrongly contained in an input prompt field and vice versa, for a particular prompt.

The prompts generated by applications 110 described in relation to FIG. 1 have a meta prompt part 212 as part of sending the request to the generative models 114, the meta prompt part 212 has a standard structure with fixed text. The meta prompt part 212 doesn't change in the life cycle of the application, it is different for each flow within the application. In other words, the meta prompt part 212 contains a common denominator that is contained within all prompts from the same application 110.

The meta prompt part 212 is a feature-specific set of instructions or contextual frameworks given to a generative AI model (e.g. the models 114 in FIG. 1) to direct and improve the quality and safety of a model’s output. Among other things, this is helpful in situations that need certain degrees of formality, technical language, or industry-specific terms. The meta prompt part 212 is usually included at the beginning of the prompt 210 and is used to prime the model with context, instructions, or other information relevant to a use case. In some implementations, the meta prompt part 214 describes the personality of the model, defines what the model should and shouldn’t answer, and defines the format of model responses. In some use cases, the meta prompt part 212 grounds an application that has provided the prompt to an overall user intent.

On the other hand, the input prompt part 214 generally corresponds to the part of the prompt 210 in which the user specifies what information or task it requires from the generative model. In some implementations, the input prompt part 214 changes in the life cycle of the application and is different in all prompts from the same application. The meta prompt part 212 is said to define an intent, whilst the user prompt part 114 is said to contain a specific instruction or instructions within that intent.

One challenge is that prompts 210 are sometimes textual unstructured entries with complex meaning, with no clear boundary between meta-prompt part 212 and changing input prompt part 214. Thus, the prompts 210 are hard to analyze and compare. As discussed, even when structured prompt objects are used, it cannot necessarily be assumed that the structure is used as intended.

Certain embodiments solve the aforementioned problem by combining two approaches: a syntactic comparison with predetermined prompts (e.g., known prompts that have been previously collected) to separate the input prompt part 214 from the meta prompt part 212, and semantically embedding those parts 212, 214 separately.

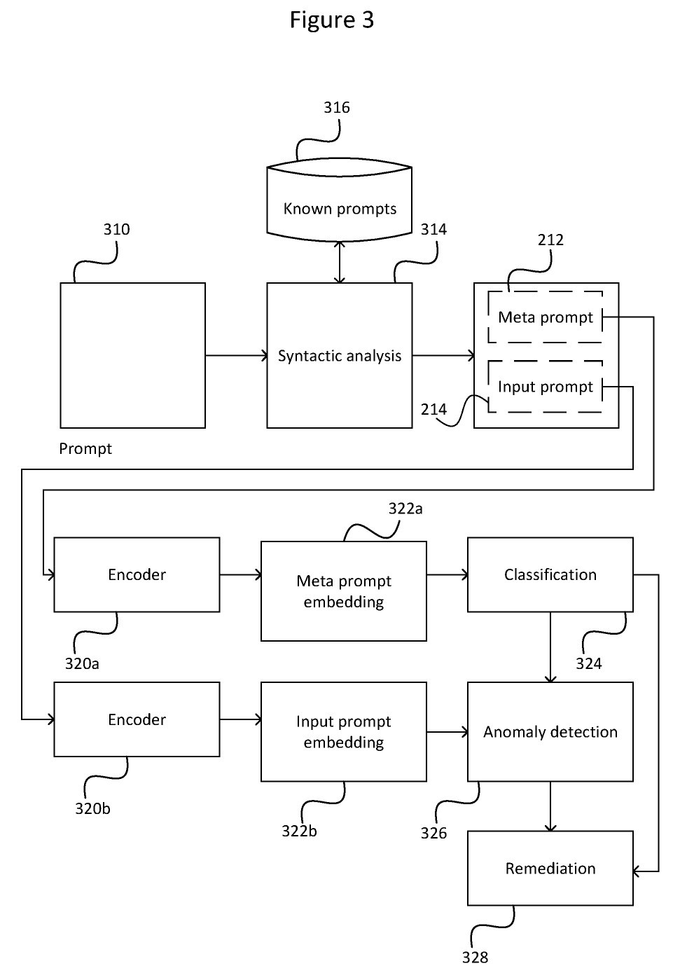

The components of FIG. 3 are described in detail below. First, various insights and principles underpinning the operation of the system are described.

Meta prompt parts and input prompt parts are differentiated using syntactic similarity by comparing parts of a prompt to predetermined prompts and finding changing and stable syntactic strings using a suitable syntactic matching method such as entropy-based matching. This step focusses on syntactic rather than semantic similarity. Stable parts represent the meta-prompt part (since they are recurring and system-generating) whereas changing parts represent dynamic (e.g., human) input likely belonging to the input part.

Syntactic similarity (that is, similarity of characters composing a prompt) is used to find the longest common prefixes in the meta prompt parts. As an example, the applications of FIG. 1 submit 1000 prompts to the gateway 112. Prompts that are submitted to the gateway 112 are then analyzed to identify their meta prompt parts. To take one illustrative example, if out of e.g., 1K API calls to the gateway 112), 400, 500 and 100 calls have respective prefixes A, B, C that are determined to be stable across those respective sub groups (e.g., 85% stable), it is determined in some cases that there are 3 types/groups of applications. Note, the aforementioned numbers are purely illustrative. In addition, this technique is used to distinguish between stable meta-prompt and changing input prompt parts.

The initial application groupings and prompt part distinctions are further improved using semantic embeddings. Creating an embedding vector for each part (meta-prompt part and input prompt part) separately captures each actual meaning and enables the parts to be stored and processed effectively. A semantic embedding approach effectively solves the challenge of textual complexity and lack of structure in prompts sent to a generative model. It also allows the creation of a common framework for gathering input and comparing other connected sources. In examples, embedding vectors are created for data used to ground the ML model, model configurations, and other inputs in various formats. Then, the embedding vectors are compared to known labels, such as labels associated with predetermined prompts, to be used as another aspect model classification (that is, financial application will be grounded on relevant specialized data and will use distinct configuration)

Embeddings from an ML model can be used to move prompt parts, such as meta prompt parts and input prompt parts, (used as tokens) to an embeddings vector space. Each data point in the embedding vector space represents an API call that submitted a prompt received to the gateway 112.

In some implementations, the meta prompt embedding vector for each API call is stored in a vector database, to enable their future usage in a security feature as described below. Since the present approach may be implemented in a production environment and the security feature has to work near real time, effective databases for storing and accessing the embedding vectors are provided.

Since parts of the prompt represent textual data, embedding vectors enable the storing and processing of this data. Embedding vectors also allow inputs from different sources to be compared.

The present example uses meta prompt and input prompt embedding vectors and adds more relevant sources (such as grounding data and model configurations). Since embedding vectors allow complex unstructured data to be captured, they are applied to any data relevant to the ML model, and the resulting embedding is moved to the same embedding space. Herein, embedding vectors are said to belong to the same embedding space if they are directly comparable, which generally means they have been generating using the same encoder logic or similar encoder logic. Thus, the ML model is correlated with respective prompts based on similarity, thus fleshing out each prompt. This additional information improves the accuracy of anomaly detection method used on prompts.

Note, it is not always necessary to encode different parts into the same embedding space. If two embedding vectors are not directly compared, they do not need to be encoded in the same embedding space. For example, a meta prompt embedding vector used to classify an application does not need to be in the same embedding space as an input prompt embedding vector used for context-aware anomaly detection based on clustering of input prompt embedding vectors. Indeed, there could be benefits in using different encoder logic in this case, to optimize the respective embedding vectors for those respective functions. On the other hand, to implement anomaly detection based on semantic mismatch between input and meta prompt embedding vectors, those embedding vectors are encoded in the same embedding space, using the same or similar encoder logic.

The present example identifies meta prompt part similarity for the prompt, in order to assign each prompt, or API call, to a specific category based on clustering. In this context, clustering based on the meta prompt embedding vector is used to classify the prompt. This allows the use of prompt embedding vectors clusters to be matched to API call (using semantic similarity), thus allowing the API call's category to be understood (by analyzing cluster recurring meaning).

Exact prompt matching is identified to detect LM application intent. This allows prompts to be matched to LM applications, thus allowing its general intent to be understood by using the prompt meaning.

Prompt anomality detection is application context aware. In one implementation, it is based on identifying an application and a category) of the application. In some such implementations, identifying the application comprises identifying an intent of the application is identified, and categorizing the application comprises categorizing it into one of several discrete categories, such as “toys designer”, “people interaction”, “chatbot “etc.

Meta-prompt and/or input-prompt part dissimilarity anomaly detection is also run. Since embedding vectors for different parts of the application, model and prompt are already clustered and stored, they are used for other security anomaly detection scenarios. For example, significant semantic dissimilarity between various parts are identified (e.g., based on determining that a distance between their respective embedding vectors is above a predetermined threshold), such as input-prompt part 212 and meta-prompt part 214. Such dissimilarity indicates attempts to use the service for unintended and potentially illegitimate purposes.

The approach presented herein has a number of uses which are described in turn below. The present approach is used for further grouping of meta-prompts to categories based on meaning which more accurately matches that of an application. In an example, meta-prompts dealing with financial operations are grouped together, even if they differ syntactically. This applies similarly to other application categories such as HR.

A meta prompt embedding vector is used to compare the meta-prompt part to known groups (finance, HR, etc.) and thus provide context for the group.

Abnormally low similarity between meta-prompt part and input prompt part signals something suspicious and in some embodiments indicates an attempt to use the application for an unintended purpose.

Semantic embeddings enable inputs from various textual/unstructured source/formats to be merged. In examples, input data, prompt parts and configurations are merged to perform a more accurate classification.

An additional benefit of the present approach is that embedding vectors can be stored and searched effectively using vector databases. In some embodiments, the interaction log 116 is implemented as an interaction database, in which embedding vectors are pre-computed and stored for subsequent analysis.

FIG. 3 is a block diagram of an example implementation of the security system 118 of FIG. 1. FIG. 3 is shown to comprise a prompt 310, a syntactic analysis component 314, prompt storage 316, a meta prompt element 212 and an input prompt element 214. A first encoder 320a and a second encoder 320b are connected to meta prompt embedding vectors 322a and input prompt embedding vectors 322b respectively. A classification component 324, an anomaly detection component 326 and a remediation component 328 are also shown in the figure.

The syntactic analysis component 314 receives the prompt and is connected to the prompt storage 316. The syntactic analysis component 314 outputs the meta prompt part 212 and the input prompt part 214 of the prompt 310. The first encoder 320a receives the meta prompt part 212 and the second encoder 320b receives the input prompt part 214. The first encoder 320a outputs the meta prompt embedding vector 322a and the second encoder 320b outputs the input prompt embedding vector 322b. The meta prompt embedding vector 322a is connected to the classification component 324. The input prompt embedding vector 322b is connected to the anomaly detection component 326. The classification component 324 is also connected to the anomaly detection component 326. The remediation component 328 is connected to the classification component 324 and the anomaly detection component 326.

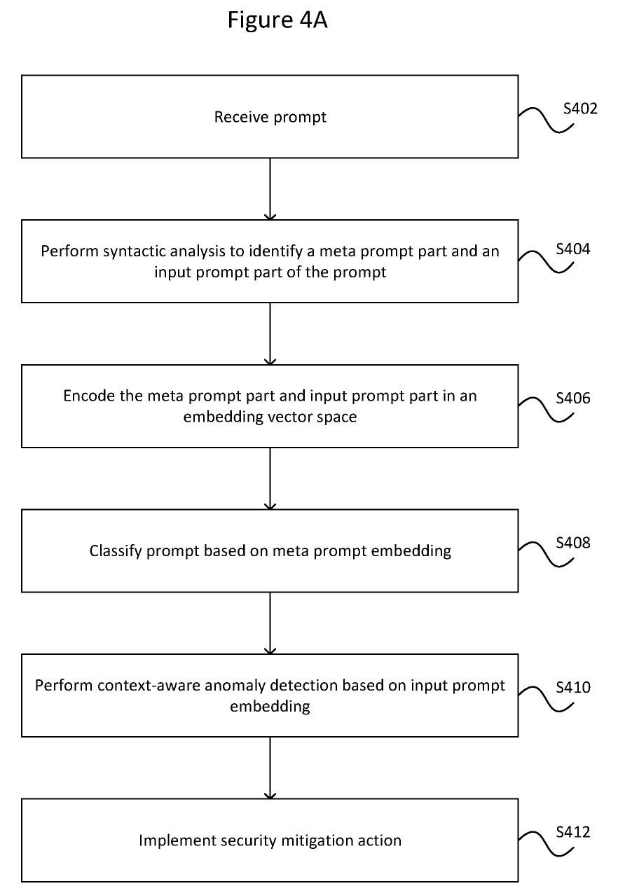

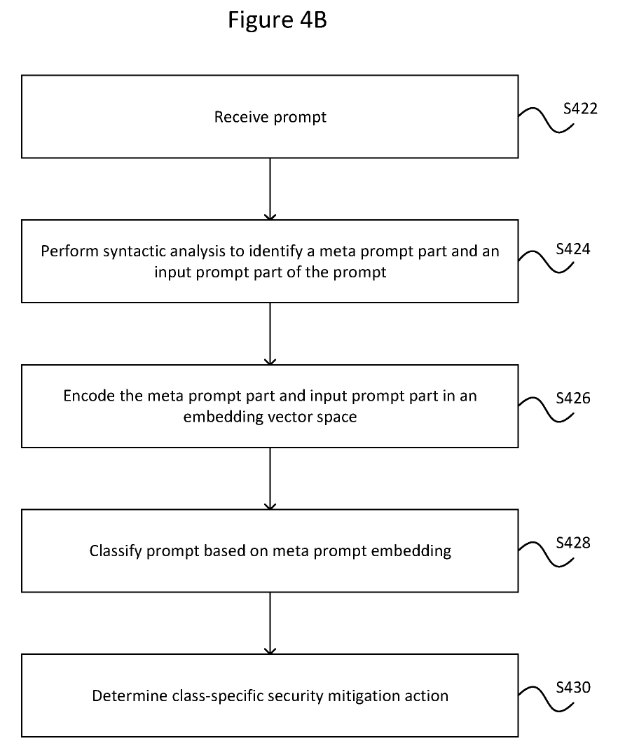

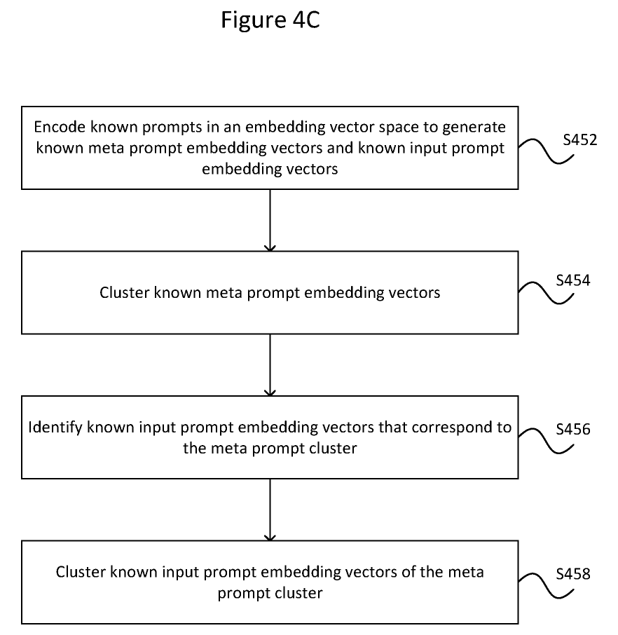

Reference is made to FIG. 4A throughout the description of FIG. 3. FIG. 4A is a flowchart of an example method implemented by the security system shown in FIG. 3.

At step S402, the syntactic analysis component 314 receives a prompt 310.

At step S404, the syntactic analysis component 314 performs syntactic analysis, as described above, using predetermined prompts stored in the prompt storage 316. In some embodiments, the predetermined prompts are captured and stored by the gateway 112 in the interaction log 116 shown in FIG. 1. The syntactic analysis component 314 identifies and extracts or otherwise determines the meta prompt part 212 and the input prompt part 214 of the prompt 310. This is done by comparing parts of the prompt 310 to predetermined prompts and find changing and stable syntactic strings using a suitable syntactic matching method such as entropy-based matching. This step focusses on syntactic rather than semantic similarity. Stable parts represent the meta-prompt part 212 (since they are recurring and system-generating) whereas changing parts represent dynamic (e.g., human) input likely belonging to the input part 214. In other words, the meta prompt part 212 and the input prompt part 214 are extracted by semantically matching the meta prompt part 212 with corresponding parts of predetermined prompts. In one implementation, the meta prompt part 212 and the input prompt part 214 are extracted without additional processing. In another implementation, the meta prompt part 212 and the input prompt part 214 are determined with additional processing, e.g. to “clean up” one or both of those parts for subsequent analysis.

At step S406, first and second encoders 320a and 320b receive the meta prompt part 212 and input prompt part 214 and separately encode those parts, resulting in a meta prompt embedding vector 322a and an input prompt embedding vector 322b respectively. In some implementations, the first and second encoders 320a, 320b are respective instances of the same encoder logic. In other implementations, they implement different encoder logic. Although first and second encoders 320a, 320b are depicted in this example, in another implementation, the same encoder is used to generate both embedding vectors 322a, 322b.

At step S408, the classification component 324 assigns the prompt 310 to a meta prompt cluster based on the meta prompt embedding vector 322a. A method of determining meta prompt clusters for this purpose is described below.

The meta prompt clusters in the embedding vector space each have an associated classification 324 or meta cluster identifier (ID). In embodiments, the meta cluster ID is determined by the relative distance between data points, representing meta prompt part embedding vectors 322a, in the embedding vector space. For example, in one example implementation, a meta cluster ID might correspond to the application type ‘Finance’ , and data points closest to and within a threshold distance of that cluster are assigned the ‘Finance’ cluster ID. All points that are beyond the threshold distance are considered to be from a different type of application and therefore are not assigned this meta cluster ID. Multiple meta prompt clusters exist in the embedding vector space, each with a unique cluster ID.

Step S408 is one way of assigning an application or application flow classification to the prompt 310 based on its meta prompt embedding vector 322a. In this context, meta cluster identifiers (ID) correspond to application/application flow types, and the prompt 310 is classified based on the meta cluster ID of the cluster to which it’s meta prompt embedding vector 322a is assigned.

In other implementations, as an alternative or in addition to clustering-based classification, another classification method is used, such as classification using a trained classification model. For example, in some implementations, a classification model is trained to classify prompts based on their meta prompt embedding vectors.

Whether through clustering or some other classification method, step S402 assigns, from a set of available classes, a class to the prompt 310 based on its meta prompt embedding vector 322a. In some embodiments, the class denotes an application type or application flow type.

An anomaly detection component 326 receives the input prompt embedding vector 322b and output from the classification component 324. The output of the classification component 324 corresponds to the meta prompt cluster identified by its meta cluster ID.

At step S410, the anomaly detection component 326 attempts to assign the prompt 310, based on its input prompt embedding vector 322b, to an input prompt cluster associated with the class assigned to the prompt 310. For example, in some implementations, that class is associated with one or multiple input prompt clusters, and the prompt 310 is assigned to one of those input prompt clusters based on its input prompt embedding vector 322b.

The input prompt embedding vectors, corresponding to the meta prompt embedding vectors in the meta prompt cluster, are also clustered. In many practical situations, there will be multiple input prompt clusters for the meta prompt cluster due to the nature and definition of the prompt parts, as discussed in relation to FIG. 2. For example, the meta prompt parts are usually fixed for a particular application whereas the input prompt parts are generally entirely customizable by a user leading to more variation.

Similarly to the meta prompt clusters, the input prompt clusters in the embedding vector space each have an associated classification or input cluster identifier (ID). In embodiments, the input cluster ID is determined by the relative distance between data points, representing input prompt part embedding vectors 322b, in the embedding vector space. All points that are beyond the threshold distance are not assigned this input cluster ID. Multiple input prompt clusters exist per individual meta prompt cluster in the embedding vector space, each with a unique input cluster ID.

The input prompt embedding vector 322b is either determined to be part of an input prompt cluster or alternatively identified as an outlier such that it is not within a threshold distance and therefore is not part of an input prompt cluster. In some embodiments, an input prompt embedding vector is identified as anomalous based on distance in embedding space from an input prompt cluster associated with an application or application flow type.

Whilst in the embodiments of FIG. 3 and FIG. 4A, context-aware anomaly detection is based on input prompt clustering, as noted other context-aware anomaly detection method can be used. For example, in alternative embodiments, a prompt 310 is identified as anomalous by the anomaly detection component 326 by performing a semantic comparison between the meta prompt embedding vector 322a and the input prompt embedding vector 322b. This is performed by considering the distance between the embedding vectors in the embedding vector space. As noted, in some such embodiments, this also leverages classification, e.g. by comparing the distance between the meta prompt embedding vector 322a and the input prompt embedding vector 322b with a class-specific threshold associated with the class assigned to the prompt 310 in step S408.

If an anomaly is detected by the anomaly detection component 326, at step S412 the remediation component 328 triggers at least one security at least one security mitigating action. In one embodiment, the remediation component 328 performs the security action (e.g., in one implementation, the remediation component 328 is implemented on a device at which the security action is performed). In another embodiments, the remediation component 328 controls a device (e.g., a device remote from the remediation component 328) to implement the security action, or otherwise causes the security action to be performed. In embodiments, an anomaly is identified as being data points that are not in or are between clusters. This, for example, represents a user using an application to access strange data or too much data. Examples of security actions that may be implemented by the remediation component 328 are discussed above in relation to FIG. 1.

FIG. 4B is a flowchart for another example method implemented by a security system. Steps S422-S428 correspond to steps S402-S408 described above in relation to FIG. 4A, and the description of those steps is not repeated in the interests of conciseness. As in FIG. 4A, at step S428, the classification component 324 assigns a class to the prompt 310 based on its meta prompt embedding vector 322a. In one embodiment, the class is a risk category, such as a risk level associated the corresponding application or application flow.

At step S430, the remediation component 328 determines a class-specific security action based on the classification determined by the classification component 324 at step S428. For example, in some implementations, the classification is a risk category (such as a “high”, “medium” or “low” risk level), and the class-specific security action is a remediation specific to the identified risk category (e.g., generating an alert or recommendation, or blocking or restricting the corresponding application if the application is determined to be high risk). A class-specific security action means a security action associated with a specific class (or specific classes).

The class-specific security action, in some embodiments, causes or recommends a modification to an application or related infrastructure based on its classification. Alternatively or additionally, in some embodiments, the class-specific security action causes an alert to be generated at an output device and/or blocks the GM prompt from reaching a generative model. For example, in some implementations, the class-specific security action blocks a model-generated response returned in response to the GM prompt and/or restricts access by an application that generated the GM prompt to a generative model. In further embodiments, the class-specific security action isolates, deactivates, or modifies an application that generated the GM prompt.

Note, the method of FIG. 4B can be implemented using only the meta prompt 212 and meta prompt embedding vector 322a, and therefore without the second encoder 320b or anomaly detection component 326 of FIG. 3. The input prompt embedding vector 322b is not required. However, alternative implementations of the method also use the input prompt embedding vector 322b. For example, in some implementations, a class-specific remediation action is triggered in response to identifying the prompt as anomalous.

FIG. 4C is a flowchart of an example prompt pre-processing method for a security system, for example the security system described in relation to FIG. 3. The methods and techniques referenced in relation to this figure are described in more detail in relation to FIGS. 3 and 4A above.

In some implementation, the method of FIG. 4C is performed “offline” in a pre-processing stage. In other implementations, the steps of FIG. 4C are performed “online”, concurrently with the method of FIG. 4A.

At step S452, meta prompt parts and input prompt parts for collected prompts (e.g., the predetermined prompts of FIG. 3) are identified and subsequently encoded in an embedding vector space. The techniques used to perform the identification and encoding correspond to the method described in relation to steps S404 and S406 of FIG. 4A above. In embodiments, the collected prompts are prompts that have previously been captured and stored in the interaction log 116 by the gateway 112. This encoding generates known meta prompt embedding vectors and known input prompt embedding vectors.

At step S454, the known meta prompt embedding vectors are clustered in the embedding vector space to generate known meta prompt clusters, resulting in the meta prompt clusters (one for each available class) used in step S408 above. In embodiments, the known meta prompt embedding vectors are clustered according the same principles set out above (e.g., clustering the predetermined prompts based on their respective meta prompt embedding vectors).

At step S456, the known input prompt embedding vectors corresponding to the known meta prompt embedding vectors in a meta prompt cluster are identified.

At step S458, the known input prompt embedding vectors of the prompts which are part of the known meta prompt cluster are also clustered into one or multiple input prompt clusters for each meta prompt cluster. Step S458 is performed to identify, for each of the available classes, the input prompt cluster(s) associated with that class.

In some embodiments, a class-specific security action is performed or triggered in response to identifying a cluster at step S454 (e.g., in response to identifying a cluster of prompts indicative of a high-risk application). In such implementations, the security action is triggered based on a cluster of multiple prompts exhibiting certain relationships to each other in embedding space, rather than an individual prompt.

Examples of suitable clustering methods suitable for either stage include k-means clustering, which partitions the data into clusters where each data point belongs to the cluster with the nearest mean; hierarchical clustering, which builds a hierarchy of clusters either by merging smaller clusters into larger ones or by splitting larger clusters into smaller ones; DBSCAN, a density-based method that groups together points that are closely packed together and marks points in low-density regions as outliers; Gaussian Mixture Models, a probabilistic model that assumes the data is generated from a mixture of several Gaussian distributions with unknown parameters; and spectral clustering, which uses eigenvalues of a similarity matrix to perform dimensionality reduction before clustering in fewer dimensions.

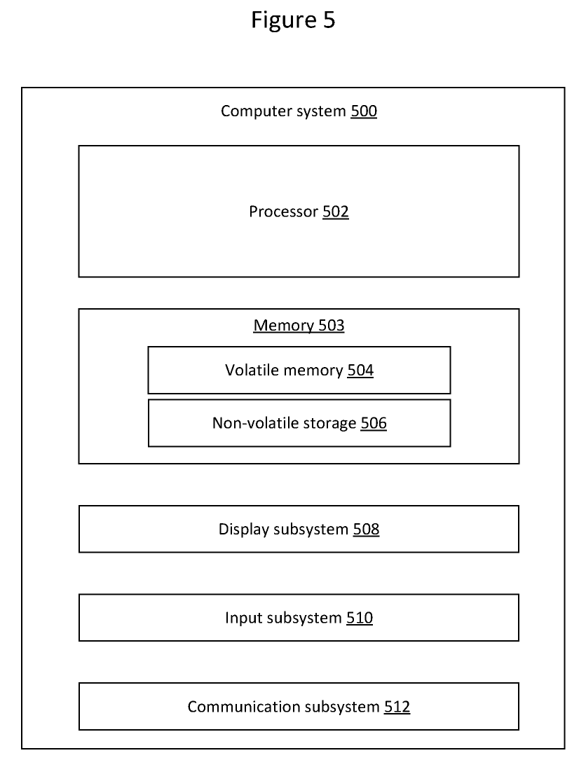

FIG. 5 schematically shows an example of a computer system 500, such as a computing device or system of connected computing devices configured to implement the security system 118 of FIG. 1.

The computer system 500 is shown in simplified form. The computer system 500 comprises a processor 502 and a memory 503. In this example, the memory 503 is shown to comprise volatile memory 504 and a non-volatile storage 506. In this example, the computer system 500 includes a display subsystem 508, an input subsystem 510, and a communication subsystem 512. In other examples, one, some or all of these components 508, 510, 512 are omitted. The processor 502 comprises one or more hardware processing units configured to carry out processing operations. A hardware processing unit may be programmable or non-programmable. Certain hardware processing units are configured to execute computer-readable instructions based on an instruction set architecture. Examples of such a hardware processing unit include a central processing unit (CPU), graphics processing unit (GPU), tensor processing unit (TPU), neural processing unit (NPU), intelligence processing unit (IPU) or other form of accelerator processing unit. Such hardware processing units may be single-core or multi-core, and instructions executed thereon may be configured for sequential, parallel, and/or distributed processing. Other examples of such hardware processing units include a field-programmable gate array (FPGAs) or a non-programmable fixed-logic circuit, such as an application-specific integrated circuit (ASIC). The processor 502 is contained in a single device in some examples. Individual components of the processor 502 are distributed among two or more separate devices in other examples. In some such examples, such devices are remotely located from each other and/or configured for coordinated processing. The non-volatile storage 506 includes one or more physical devices configured to hold data and/or computer-readable instructions executable by the processor 502. Examples of non-volatile storages include optical memory (e.g., CD, DVD, HD-DVD, Blu-Ray Disc, etc.), semiconductor memory (e.g., ROM, EPROM, EEPROM, FLASH memory, etc.), magnetic memory (e.g., hard-disk drive), or other mass storage device technology. The volatile memory 504 includes one or more physical devices that include random access memory in some examples. The volatile memory 504 is typically utilized by processor 502 to temporarily store data and/or instructions during processing. The terms “module,” “program,” and “engine” are used to describe particular functionality of the computer system 500 implemented in hardware or software. In some examples, a software module, program, or engine is instantiated via the processor 502 executing instructions held by non-volatile storage 506, using portions of the volatile memory 504. Different modules, programs, and/or engines are instantiated from the same application, service, code block, object, library, routine, API, function, etc. in some examples. In other examples, the same module, program, and/or engine are instantiated by different applications, services, code blocks, objects, routines, APIs, functions, etc. The terms “module,” “program,” and “engine” encompass among other things individual or groups of executable files, data files, libraries, drivers, scripts, database records, etc. The display subsystem 508 is configurable to present a visual representation of data such as data held by the non-volatile storage 506. The visual representation takes the form of a graphical user interface (GUI) in some examples. The display subsystem 508 includes one or more display devices utilizing virtually any type of technology. Such display devices are combined with processor 502, volatile memory 504, and/or non-volatile storage 506 in a shared enclosure in some examples. In other examples, such display devices are peripheral display devices. The input subsystem 510 comprises or interfaces with one or more input devices such as user-input devices such as a keyboard, mouse, touch screen, or game controller. In some embodiments, the input subsystem 510 comprises or interfaces with selected natural user input (NUI) componentry. Such componentry may be integrated or peripheral, and the transduction and/or processing of input actions may be handled on-board or off-board. Examples of NUI componentry include without limitation a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor. The communication subsystem 512 is configured to communicatively couple the computer system 500 to another device or system. The communication subsystem 512 may include wired and/or wireless communication devices compatible with one or more different communication protocols. In some examples, the communication subsystem 512 allows computer system 500 to send and/or receive messages to and/or from other devices via a communication network such as the internet. The term computer readable media as used herein includes for example computer storage media. Computer storage media includes for example volatile and non-volatile, removable and nonremovable media (e.g., volatile memory 504 or non-volatile storage 506). Computer storage media includes for example solid-state storage, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by a computing device (e.g., the computer system 500 or a component device thereof). Computer storage media does not include a carrier wave or other propagated or modulated data signal. Communication media is embodied by computer readable instructions, data structures, program modules, or other data in a modulated data signal, such as a carrier wave or other transport mechanism, and includes any information delivery media. The term “modulated data signal” describes a signal that has one or more characteristics set or changed in such a manner as to encode information in the signal. Examples of communication media include without limitation wired media such as a wired network or direct wired connection, and wireless media such as acoustic, radio frequency (RF), infrared, and other wireless media.

Additional example features of the disclosure are set out below.

According to a first aspect of the disclosure there is provided a computer-implemented method, comprising: determining based on a generative model (GM) prompt a meta prompt part and an input prompt part; encoding the meta prompt part, resulting in a meta prompt embedding vector; encoding the input prompt part, resulting in an input prompt embedding vector; based on the meta prompt embedding vector and the input prompt embedding vector, identifying the GM prompt as anomalous; and based on identifying the GM prompt as anomalous, triggering a security action.

The method may comprise: assigning a class to the GM prompt based on the meta prompt embedding vector; and identifying the GM prompt as anomalous based on the class and the input prompt embedding vector.

In embodiments, assigning the class to the GM prompt may comprise assigning the GM prompt to an meta prompt cluster based on the meta prompt embedding vector.

The class may denote an application type or application flow type.

The input prompt embedding vector may be identified as anomalous based on distance in embedding space from an input prompt cluster associated with the application type or application flow type.

Determining the meta prompt part and input prompt part may comprise syntactically matching the meta prompt part with corresponding parts of predetermined GM prompts.

The security action may comprise: causing an alert to be generated at an output device, blocking the GM prompt, blocking a model-generated response returned in response to the GM prompt, restricting access by an application that generated the GM prompt to a generative model, or isolating, deactivating, or modifying an application that generated the GM prompt.

Identifying the GM prompt as anomalous may be based on a distance between the meta prompt embedding vector and the input prompt embedding vector.

The method may comprise: assigning a class to the GM prompt based on the meta prompt embedding vector, wherein identifying the GM prompt as anomalous comprises comparing the distance with a threshold associated with the class to which the GM prompt is assigned.

According to a second aspect of the disclosure there is provided computer-readable storage medium embodying computer-readable instructions, which when executed on a processor, cause the processor to implement operations comprising: determining based on a generative model (GM) prompt a meta prompt part; encoding the meta prompt part, resulting in a meta prompt embedding vector; assigning a class to the GM prompt based on the meta prompt embedding vector; based on assigning the class to the GM prompt, determining a security action associated with the class; and causing the security action to be performed.

In embodiments, the computer-readable storage medium embodying computer-readable instructions, which when executed on a processor, may cause the processor to implement further operations comprising: determining based on the GM prompt an input prompt part; encoding the input prompt part, resulting in an input prompt embedding vector; based on the input prompt embedding vector, identifying the GM prompt as anomalous, wherein the security action is associated with the class is caused to be performed based on identifying the GM prompt as anomalous.

The class may be a risk category.

Assigning the class to the GM prompt may comprise assigning the GM prompt to a meta prompt cluster based on the meta prompt embedding vector.

The security action may be caused to be performed in response to identifying the meta prompt cluster.

The class may denote an application type or application flow type.

The input prompt embedding vector may be identified as anomalous based on distance in embedding space from an input prompt cluster associated with the application type or application flow type.

Determining the meta prompt part and input prompt part may comprise syntactically matching the meta prompt part with corresponding parts of predetermined GM prompts.

The security action may comprise: causing an alert to be generated at an output device, blocking the GM prompt, blocking a model-generated response returned in response to the GM prompt, restricting access by an application that generated the GM prompt to a generative model, or isolating, deactivating, or modifying an application that generated the GM prompt.

The optional features defined above in relation to the second aspect may be combined in any combination. Accordingly, each sentence in the optional features defined above can be read as if it is a dependent claim referring to the features of any preceding sentence.

According to a third aspect of the present disclosure there is provided a computer system, comprising: a processor; and a memory coupled to the processor and embodying computer-readable instructions, which when executed on the processor, cause the computer system to implement operations comprising: determining based on a generative model (GM) prompt a meta prompt part and an input prompt part; encoding the meta prompt part, resulting in a meta prompt embedding vector; encoding the input prompt part, resulting in an input prompt embedding vector; computing a distance between the meta prompt embedding vector and the input prompt embedding vector; based on the distance between the meta prompt embedding vector and the input prompt embedding vector, identifying the GM prompt as anomalous; and based on identifying the GM prompt as anomalous, triggering a security action.

In embodiments, the operations may comprise assigning a class to the GM prompt based on the meta prompt embedding vector, wherein identifying the GM prompt as anomalous may comprise comparing the distance with a threshold associated with the class to which the GM prompt is assigned.

The optional features defined above in relation to the third aspect may be combined in any combination. Accordingly, each sentence in the optional features defined above can be read as if it is a dependent claim referring to the features of any preceding sentence.

Furthermore, the optional features of the first, second and third aspect may be combined in any combination.

The embodiments described above are illustrative and not exhaustive. Further embodiments are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the present disclosure. The scope is not defined by the described embodiments but only by the accompanying claims.

1. A computer-implemented method, comprising:
determining based on a generative model (GM) prompt a meta prompt part and an input prompt part;
encoding the meta prompt part, resulting in a meta prompt embedding vector;
encoding the input prompt part, resulting in an input prompt embedding vector;
based on the meta prompt embedding vector and the input prompt embedding vector, identifying the GM prompt as anomalous; and
based on identifying the GM prompt as anomalous, triggering a security action.

2. The computer-implemented method of claim 1, comprising:
assigning a class to the GM prompt based on the meta prompt embedding vector; and
identifying the GM prompt as anomalous based on the class and the input prompt embedding vector.

3. The computer-implemented method of claim 2, wherein assigning the class to the GM prompt comprises assigning the GM prompt to an meta prompt cluster based on the meta prompt embedding vector.

4. The computer-implemented method of claim 3, wherein the class denotes an application type or application flow type.

5. The computer-implemented method of claim 4, wherein the input prompt embedding vector is identified as anomalous based on distance in embedding space from an input prompt cluster associated with the application type or application flow type.

6. The computer-implemented method of claim 1, wherein determining the meta prompt part and input prompt part comprises syntactically matching the meta prompt part with corresponding parts of predetermined GM prompts.

7. The computer-implemented method of claim 1, wherein the security action comprises:
causing an alert to be generated at an output device,
blocking the GM prompt,
blocking a model-generated response returned in response to the GM prompt,
restricting access by an application that generated the GM prompt to a generative model, or
isolating, deactivating, or modifying an application that generated the GM prompt.

8. The computer-implemented method of claim 1, wherein identifying the GM prompt as anomalous is based on a distance between the meta prompt embedding vector and the input prompt embedding vector.

9. The computer-implemented method of claim 8, comprising:
assigning a class to the GM prompt based on the meta prompt embedding vector, wherein identifying the GM prompt as anomalous comprises comparing the distance with a threshold associated with the class to which the GM prompt is assigned.

10. A computer-readable storage medium embodying computer-readable instructions, which when executed on a processor, cause the processor to implement operations comprising:
determining based on a generative model (GM) prompt a meta prompt part;
encoding the meta prompt part, resulting in a meta prompt embedding vector;
assigning a class to the GM prompt based on the meta prompt embedding vector;
based on assigning the class to the GM prompt, determining a security action associated with the class; and
causing the security action to be performed.

11. The computer-readable storage medium of claim 10, wherein the processor implements further operations comprising:
determining based on the GM prompt an input prompt part;
encoding the input prompt part, resulting in an input prompt embedding vector;
based on the input prompt embedding vector, identifying the GM prompt as anomalous, wherein the security action is associated with the class is caused to be performed based on identifying the GM prompt as anomalous.

12. The computer-readable storage medium of claim 10, wherein determining the meta prompt part and input prompt part comprises syntactically matching the meta prompt part with corresponding parts of predetermined GM prompts.

13. The computer-readable storage medium of claim 10, wherein the class is a risk category.

14. The computer-readable storage medium of claim 10, wherein assigning the class to the GM prompt comprises assigning the GM prompt to a meta prompt cluster based on the meta prompt embedding vector.

15. The computer-readable storage medium of claim 14, wherein the security action is caused to be performed in response to identifying the meta prompt cluster.

16. The computer-readable storage medium claim 15, wherein the input prompt embedding vector is identified as anomalous based on distance in embedding space from an input prompt cluster associated with the application type or application flow type.

17. The computer-readable storage medium of claim 10, wherein the class denotes an application type or application flow type.

18. The computer-readable storage medium of claim 10, wherein the security action comprises:
causing an alert to be generated at an output device,
blocking the GM prompt,
blocking a model-generated response returned in response to the GM prompt,
restricting access by an application that generated the GM prompt to a generative model, or
isolating, deactivating, or modifying an application that generated the GM prompt.

19. A computer system, comprising:
a processor; and
a memory coupled to the processor and embodying computer-readable instructions, which when executed on the processor, cause the computer system to implement operations comprising:
determining based on a generative model (GM) prompt a meta prompt part and an input prompt part;
encoding the meta prompt part, resulting in a meta prompt embedding vector;
encoding the input prompt part, resulting in an input prompt embedding vector;
computing a distance between the meta prompt embedding vector and the input prompt embedding vector;
based on the distance between the meta prompt embedding vector and the input prompt embedding vector, identifying the GM prompt as anomalous; and
based on identifying the GM prompt as anomalous, triggering a security action.

20. The computer system of claim 19, wherein the operations comprise assigning a class to the GM prompt based on the meta prompt embedding vector, wherein identifying the GM prompt as anomalous comprises comparing the distance with a threshold associated with the class to which the GM prompt is assigned.
